(19) United States
(12) Patent Application Publication
(10) Pub. No.: US 2026/0268104 A1
(43) Pub. Date: Sep. 10, 2026

(54) METHOD FOR READING BAR CODES

(71) Applicant: SICK AG, Waldkirch (DE)

(72) Inventors: Julian ZIMMER, Freiburg (DE); Jonathan STEINBUCH, Denzlingen (DE)

(21) Appl. No.: 19/306,244

(22) Filed: Aug. 21, 2025

(30) Foreign Application Priority Data
Aug. 22, 2024 (DE) 10 2024 124 050.4

(51) Int. Cl. G06K 7/14

(52) U.S. Cl. CPC G06K 7/1452; G06K 7/1473

(57) ABSTRACT

The invention relates to a method for reading barcodes that comprises that: a barcode is captured by means of an image acquisition apparatus, said barcode comprising barcode elements in the form of bars and spaces, wherein the bars and the spaces arranged between the bars are arranged in an alternating manner, wherein a respective bar and/or a respective space can be assigned to a width level of a predefined number of width levels, wherein each width level has a respective reference width; an edge field is generated based on the captured barcode, wherein an edge in the edge field indicates a bar-space transition; using the edge field, a similarity value is determined that indicates a similarity between a distribution of bar width values and a distribution of space width values; wherein an adjustment of the edge field takes place when the similarity value satisfies a predetermined condition; and the barcode is decoded based on the edge field and/or the adjusted edge field.

The invention relates to methods for reading barcodes and to an optoelectronic code reading apparatus.

The precise and efficient reading of barcodes is a key challenge in barcode technology, in particular when dealing with distortions caused by overprinting and overexposure. Overprinting occurs when an inkjet printer applies too much ink to the paper, which leads to the bars of a barcode becoming uniformly wider and the spaces between them becoming correspondingly narrower. In contrast, overexposure causes the bars to appear narrower and the spaces correspondingly wider due to excessive light on the barcode. The spaces between the bars can also be considered gaps between the bars.

Current technologies for decoding barcodes in such problematic situations rely on a “brute force” methodology known as “jittering”. In this approach, a gray value scan of the barcode is first binarized, i.e. converted into a black and white representation, in order to generate an edge field. Two additional variants are then created from this edge field. In a first variant, bars are widened by a predefined value and the spaces are narrowed accordingly, whereas, in a second variant, the spaces are widened by a predefined value and the bars are narrowed accordingly. The original variant of the edge field and the two generated variations are transferred to the decoder in the hope that one of the two variants will compensate for an overexposure effect or overprinting effect.

However, this method has considerable disadvantages. On the one hand, the generation and decoding of three edge fields instead of just one increases the decoding load by up to 200%, which leads to a massive increase in the decoding time. This indeed increases the success rate in problematic reading situations such as overprinting or overexposure, but such problems rarely occur compared to normal reading processes. This means that the general reading speed is impaired, even if there are no distortions. Furthermore, the jittering process can lead to further problems, such as the generation of unnecessary edge field variants that can impair the reading accuracy. For example, an incorrectly adjusted variant can increase the overprinting effects or overexposure effects and can thus lead to a deterioration in the readability of the barcode.

It is an object of the invention to provide an improved method for reading barcodes and a corresponding optoelectronic code reading apparatus.

This object is satisfied by the subjects of the independent claims.

A first aspect of the invention relates to a method for reading barcodes that comprises that:
a barcode is captured by means of an image acquisition apparatus, said barcode comprising barcode elements in the form of bars and spaces, wherein the bars and the spaces arranged between the bars are arranged in an alternating manner, wherein a respective bar and/or a respective space can be assigned to a width level of a predefined number of width levels, wherein each width level has a respective reference width;
an edge field is generated based on the captured barcode, wherein an edge in the edge field indicates a bar-space transition;
using the edge field, a similarity value is determined that indicates a similarity between a distribution of bar width values and a distribution of space width values;
wherein an adjustment of the edge field takes place when the similarity value satisfies a predetermined condition;
and the barcode is decoded based on the edge field and/or the adjusted edge field.

In other words, before an adjustment of the edge field, it is checked whether the distribution of the width values of the bars occurring in the edge field and the distribution of the width values of the spaces occurring in the edge field deviate significantly from one another. A significant deviation can, for example, be determined by the similarity value. In particular, the strength of the deviation can be determined based on the similarity value. A particularly strong deviation can, for example, be determined by a low similarity value, while a small deviation can be determined by a high similarity value.

As already described, an overexposure situation has the effect that the width of a respective bar becomes smaller over the entire edge field, in particular smaller than the reference width of the associated width level, and the width of a respective space becomes larger, in particular larger than the reference width of the associated width level. In an overprinting situation, on the other hand, the opposite effect occurs, i.e., over the entire edge field, the width of a respective bar becomes larger, in particular larger than the reference width of the associated width level, and the width of a respective space becomes smaller, in particular smaller than the reference width of the associated width level.

For the sake of simplicity, the case of the overprinting situation is used in the following to describe the invention. However, the effect of the invention can also be described with reference to the overexposure situation, wherein the effects on the spaces and bars for this case are to be adjusted in accordance with the above statements.

The invention is based on the basic idea that a distortion effect that is caused, for example, by overprinting or overexposure is in particular reflected in the distribution of the bar width values and the space width values. The overprinting effect, for example, leads to a shift in the distribution of the bar width values in the direction of higher width values, i.e. along the width value axis in a positive X direction. At the same time, the overprinting effect leads to a shift in the distribution of the space width values in the direction of lower width values, i.e. along the width value axis in a negative X direction. The respective shift in particular depends on the strength of the overprinting. The overprinting thus has an opposite effect on the distribution of the bar width values and the distribution of the space width values since the two distributions are shifted in opposite directions. This opposite effect and thus the existence of an overprinting situation can therefore be determined based on a comparison of the distribution of bar width values and the distribution of space width values. The bar width values and space width values in particular indicate the width values of the corresponding bars and spaces of the edge field.

To determine a distortion situation, a similarity value is determined that indicates a similarity between the distribution of the bar width values and the distribution of the space width values. If the similarity value satisfies a predetermined condition, for example, if the similarity value falls below a predetermined similarity threshold value, an adjustment of the edge value takes place. In all other cases, an adjustment can be dispensed with since the distribution of the bar width values and the distribution of the space width values is sufficiently similar, i.e. there is a small deviation, for example, if the similarity value exceeds a predetermined similarity threshold value, and the presence of a distortion situation, e.g. an overprinting situation or an overexposure situation, can hereby be ruled out. The decoding of the barcode takes place solely based on the edge field and/or the adjusted edge field. In particular if an adjustment has taken place, the decoding of the barcode takes place based on the adjusted edge field. If, on the other hand, no adjustment has taken place, the decoding of the barcode, for example, takes place based on the edge field. The decoded information can then be used to control an industrial machine, e.g. a (parcel) sorting machine or a robot for warehouse management, for product identification, for the tracking of parcels and the like.

The method in particular relates to barcodes in which the bars and spaces are assigned to corresponding width levels, i.e. the barcode uses a predefined number of width levels for spaces and a predefined number of width levels for bars, wherein the width levels for the bars and the width levels for the spaces are preferably identical. In particular, the respective width levels have different reference widths. The reference width of a respective width level can correspond to a multiple of the reference width of a first width level. For example, the reference width of a second width level can correspond to twice the reference width of the first width level and the reference width of a third width level can correspond to three times the reference width of the first width level, etc. The reference width of the first width level can be the module size, for example. The reference widths of the width levels can, for example, be predefined by a standard, e.g. UPC, Code 128 or Code 39.

As already described, the edge field is generated based on the captured barcode. For example, the barcode is captured as a gray value scan and is converted into an edge field that corresponds to a binarized representation of the captured gray value scan, i.e. a black and white representation. An edge in the edge field can further be characterized by a transition from a region of lower intensity to a region of higher intensity, or vice versa, e.g. by a black-white transition. It is also conceivable that the orientation of the detected barcode or the edge field is adjusted if said orientation does not correspond to a preferred reading direction. For example, the orientation of the captured barcode or of the edge field can be adjusted based on an angle of the edges so that the edges of the oriented captured barcode or the oriented edge field extend vertically.

The bars and spaces represent barcode elements that extend in a horizontal direction and in a vertical direction, wherein the width of the spaces and the width of the bars refer to an extent in a horizontal direction. The bars of a captured barcode are represented in the edge field, for example, by a group of black pixels, while the spaces are represented by a group of white pixels. Furthermore, the width of the bars and the width of the spaces is preferably specified in pixels, i.e. the width value x corresponds to the width of x pixels. When a bar or a space in relation to the edge field is mentioned above or below, this refers to the representation of a respective bar or a respective space of the barcode in the edge field, wherein this representation can deviate from the actual representation on the barcode, for example, due to an overexposure effect.

According to the invention, the decoding load is reduced such that new, i.e. adjusted, edge fields are only generated if a problematic situation, e.g. an overexposure situation or an overprinting situation, is present. Furthermore, the performance of the decoding is improved since in many cases no edge fields are generated, which leads to a saving of calculation time in the subsequent individual decoders. In cases in which an adjustment is required and performed, only one adjusted edge field is furthermore generated, whereas, according to the jittering method of the prior art, two edge field variations are always generated, of which one variant even comprises a reinforcement of the problem.

Further embodiments of the invention can be seen from the description, from the dependent claims and from the drawings.

According to a first embodiment, the distribution of the bar width values is determined based on a normalized bar width histogram and the distribution of the space width values is determined based on a normalized space width histogram, wherein the similarity value z_{sim,1} is, for example, determined based on the following equation:

$${z}_{s i m , 1} = 1 - {\sum }_{i} \frac{{( {b}_{i} - {l}_{i} )}^{2}}{2 * ( {b}_{i} - {l}_{i} )} \qquad ( 1 )$$

where bᵢ indicates the histogram value of the bar width histogram for the ith width value and lᵢ indicates the histogram value of the space width histogram for the ith width value, wherein an adjustment of the edge field takes place if the similarity value is less than a predetermined similarity threshold value.

The bar width histogram and the space width histogram are in particular created based on the bar width values occurring in the edge field and the space width values occurring in the edge field. The histogram values in particular indicate a relative frequency of the occurring width values, wherein a histogram value of 0 is assigned to a width value that does not occur. For example, the histogram values of the bar width histogram indicate a relative frequency of the occurring bar width values, while the histogram values of the space width histogram indicate a relative frequency of the occurring space width values. The Y axis of a respective histogram thus indicates the relative frequency and the X axis indicates the width value. By normalizing the histogram values, the sum of the histogram values of the bar width histogram and the sum of the histogram values of the space width histogram are 1 in each case. The bar width values and the space width values can be specified as integer values that indicate the respective width in dependence on the number of pixels, i.e. the width value 2 corresponds to the width of 2 pixels, for example. The use of integer values inter alia serves to simplify the calculations. The similarity value z_{sim,1} can assume values between 0 and 1, wherein the value 1 indicates a maximum similarity and the value 0 indicates a maximum dissimilarity. If the similarity value is thus smaller than a predetermined similarity threshold value, it can be determined that an overprinting situation or overexposure situation is present. The similarity threshold value can, for example, be determined in advance by means of a heuristic, e.g. based on empirical values, or can be determined by an AI. The similarity value z_{sim,1} is in particular calculated according to the qui-square similarity (cf. equation 1). The determination of a distortion situation based on the determined similarity value is particularly reliable and robust in this embodiment.

According to one embodiment, the distribution of the bar width values is determined based on a normalized bar width histogram and the distribution of the space width values is determined based on a normalized space width histogram, wherein a first estimate z₁ of a reference width of a first width level takes place on the basis of the bar width values and a second estimate z₂ of the reference width of the first width level takes place on the basis of the space width values, wherein the similarity value z_{sim,2} is determined based on a difference between the first estimate z₁ and the second estimate z₂.

This embodiment is based on the idea that the shift of the bar width histogram and the space width histogram that is caused by a distortion effect, e.g. overprinting or overexposure, can be determined based on the difference or the offset of a first estimate of the reference width of a width level, which is based on the bar width values, and a second estimate of the reference width of the same width level, which is based on the space width values. This is based on the realization that the first estimate and the second estimate are close to one another in a non-distorted case and thus a difference between the first estimate and the second estimate is small, while the distance between the first estimate and the second estimate increases with an increasing distortion. The similarity value z_{sim,2} can, for example, correspond to the amount of the difference between the first estimate and the second estimate:

$${z}_{s i m , 2} = \vert {z}_{1} - {z}_{2} \vert \qquad ( 2 )$$

where z₁ corresponds to the first estimate and z₂ to the second estimate. Accordingly, an adjustment of the edge field can take place if the similarity value is larger than a predetermined similarity threshold value. If the first estimate is larger than the second estimate by the predetermined similarity threshold value, an overprinting situation can be determined, for example. In the opposite case, an overexposure situation can be determined.

Alternatively, the similarity value z_{sim,2} can be determined based on the following equation:

$${z}_{s i m , 2} = \frac{1}{{e}^{\vert {z}_{1} - {z}_{2} \vert}} \qquad ( 3 )$$

where z₁ corresponds to the first estimate and z₂ to the second estimate. The similarity value z_{sim,2} can assume values between 0 and 1 according to equation 3, where the value 1 indicates a maximum similarity and the value 0 indicates a maximum dissimilarity. In this case, an adjustment of the edge field takes place, for example, if the similarity value is smaller than a predetermined similarity threshold value.

The similarity threshold value z_{sim,2} can, for example, be defined in advance by means of a heuristic, e.g. based on empirical values, or can be determined by an AI. This embodiment is characterized in that the determination of the similarity value takes place comparatively quickly, wherein a lower robustness of the results compared to the first embodiment is accepted.

Unless otherwise stated, the terms “first estimate” and “second estimate” below refer to the first estimate of the reference width of the first width level on the basis of the bar width values and the second estimate of the reference width of the first width level on the basis of the space width values.

According to one embodiment, the first estimate z₁ takes place using the normalized bar width histogram, wherein the histogram values of the bar width histogram are added up according to the following equation:

$${b}_{s u m} = {\sum }_{i = 1}^{x} {b}_{i} \qquad ( 4 )$$

where bₛᵤₘ corresponds to the sum of the bar width histogram values for the first to xth width value, bᵢ corresponds to the bar width histogram value for the ith width value, i indicates the index of the width value, and x indicates the index of the width value for which the condition bₛᵤₘ>first threshold value is satisfied, wherein the xth width value is defined as the first estimate z₁ or the first estimate z₁ is calculated as a weighted bar width value according to the equation

$${z}_{1} = {\sum }_{i = 1}^{x} \frac{{b}_{i}}{{b}_{s u m}} \cdot B ( i ) ,$$

where B(i) indicates the ith width value,
wherein the second estimate z₂ takes place using the normalized space width histogram, wherein the histogram values of the space width histogram are added up according to the following equation:

$${l}_{s u m} = {\sum }_{i = 1}^{y} {l}_{i} \qquad ( 5 )$$

where lₛᵤₘ corresponds to the sum of the space width histogram values for the first to xth width value, lᵢ corresponds to the space width histogram value for the ith width value, i indicates the index of the width value, and y indicates the index of the width value for which the condition lₛᵤₘ>second threshold value is satisfied, wherein the yth width value is defined as the second estimate z₂ or the second estimate z₂ is calculated as a weighted space width value according to the equation

$${z}_{2} = {\sum }_{i = 1}^{y} \frac{{l}_{i}}{{l}_{s u m}} \cdot B ( i ) ,$$

where B(i) indicates the ith width value.

In other words, starting with the histogram value of the smallest width value, i.e. the bar width value or space width value for i=1, wherein the width value for i=1 corresponds, for example, to a pixel width, the histogram values, i.e. the relative frequency of the width values, are added up iteratively until the added-up histogram value exceeds a first or second threshold value. This condition ensures that at least a predetermined, in particular relative, number of width values are considered for the determination of the first or second estimate. The predetermined relative number is determined, for example, by the first or second threshold value. The xth or yth width value of the associated histogram value, from which this condition is satisfied, can be defined as the first or second estimate. Alternatively, the first or second estimate can be determined as a weighted estimate, wherein, for example, the relative frequency of the individual occurring width values for i=1 to i=x or i=y are considered in the calculation of the first or second estimate by the weighted estimate.

In particular, the first threshold value corresponds to the second threshold value. Furthermore, the first and/or second threshold value can be defined in dependence on the number of width levels. For example, the first and/or second threshold value can be smaller than

$$\frac{1}{Number of width levels} .$$

In particular, the first and/or second threshold value is 0.2 or 0.25 if the predefined number of width levels is 4. Alternatively, the first and/or second threshold value can be 0.4 or 0.5 if the predefined number of width levels is 2.

According to one embodiment, the reference width of the first width level is the module size. The module size is known to correspond to the desired width of the narrowest individual bar and/or the narrowest space in the barcode. As a rule, the desired width of the narrowest individual bar is equal to the desired width of the narrowest individual space. The module size, for example, serves as a basic dimension, starting from which the further reference widths of the bars and spaces can be determined. The module size can, for example, be specified in millimeters or inches, preferably in pixels. The module size has the smallest reference width compared to the reference widths of the further width levels. The module size and/or the reference widths of the further width levels are in particular known.

The module size can vary depending on the purpose of use of the barcode. According to the UPC-A code, the module size, for example, amounts to approximately 0.26 mm (0.01 inches). According to Code 128, the module size can vary, but is often between 0.254 mm (0.01 inches) and 0.508 mm (0.02 inches), depending on the print resolution and the purpose of use. In Code 39, the module size can likewise vary, but it is typically between 0.508 mm (0.02 inches) and 1.27 mm (0.05 inches).

According to one embodiment, the edge field comprises a plurality of pixels, wherein the pixels associated with a bar have a first pixel color and the pixels associated with a space have a second pixel color that is different from the first pixel color, wherein the similarity value corresponds to a ratio of pixels having a first pixel color and pixels having a second pixel color, wherein an adjustment of the edge field takes place if the similarity value is larger than a predetermined first similarity threshold value or smaller than a second similarity threshold value.

Typically, the first pixel color is black and the second pixel color is white. Since an overprinting situation or overexposure situation causes the bars of a barcode to become wider and the spaces to become narrower at the same time, or vice versa, such a situation also causes the ratio of white to black pixels in the edge field of an overprinted or overexposed code to change or shift in comparison with the “perfect” reference barcode. To recognize the presence of a distortion situation, the ratio of white to black pixels can therefore be calculated, wherein a strongly deviating ratio indicates overprinting or overexposure.

By means of a heuristic, for example, a low first similarity threshold value, in particular compared to a second similarity threshold value, can be defined for the detection of an overprinting and a high second similarity threshold value, in particular compared to the first similarity threshold value, can be defined for the detection of an overexposure when the ratio

$$\frac{Number of white pixels}{Number of black pixels}$$

is determined. One advantage of this method is the fast calculation since it does not require a time-consuming creation and analysis of histograms.

According to one embodiment, the similarity value is generated using an AI, wherein the training data of the AI comprise a plurality of sample edge fields and associated labels, wherein the label of an associated sample edge field indicates a similarity between a distribution of bar width values of the associated sample edge field and a distribution of space width values of the associated sample edge field. The AI can furthermore also have been trained using data of the aforementioned bar width histogram and the space width histogram as training data. The AI can further comprise an image recognition AI, e.g. a CNN or an autoencoder. Furthermore, the aforementioned heuristic methods can be used in combination with the AI to generate the similarity value.

According to one embodiment, the adjustment of the edge field comprises that a shift value is determined based on an estimate difference that corresponds to a difference of the first estimate and the second estimate, and the edge field is adjusted based on the shift value. As already described above, a distortion situation can be determined based on the difference between the first estimate and the second estimate. In particular, the estimate difference indicates an extent or a strength of the distortion. The estimate difference can thus also be used to compensate for the distortion effect, for example, by shifting the edges of the edge field by a shift value that is based on the estimate difference. In particular, all the edges of the edge field are shifted by the same shift value. This is due to the fact that the distortion effect influences the bars and spaces of the barcode or of the edge field to the same extent. Accordingly, the change in the position of an edge compared to its previous reference position, said change caused by the distortion effect, relates to each edge to the same extent. A holistic, generic solution approach, in which all the edges are adjusted or shifted in the same way, is therefore sensible. An adjusted edge field variant is therefore generated, wherein, in contrast to the jittering method of the prior art, in which the adjustment takes place based on predefined shift values, the adjusted edge field variant is generated based on the differences, extracted from the edge field, between the distribution of the bar width values and the space width values. This procedure can therefore also be understood as a kind of “adaptive jittering”.

One advantage of this adaptive process is that it is much better adjusted to the reading situation. The global shift with the determined shift value, which shifts the edges of the edge field such that a distortion situation is compensated, is precisely determined so that it counteracts the real situation in the edge field. Thus, a more pronounced correction takes place in the case of a stronger overprinting than in the case of a slight overprinting. The same applies to cases with overexposure.

According to one embodiment, a histogram shift value is determined based on the estimate difference (method step 1), wherein the bar width histogram and/or the space width histogram is/are shifted by the histogram shift value (method step 2), wherein a further similarity value is determined in accordance with one of the above methods for the shifted bar width histogram and the space width histogram, for the shifted space width histogram and the bar width histogram, or for the shifted bar width histogram and the shifted space width histogram (method step 3), wherein an adjustment of the edge field takes place based on the shift value, which is determined based on the histogram shift value, when the further similarity value satisfies a predetermined condition (method step 4).

Before an adjustment of the edge field takes place, it can thus be checked whether a shift leads to an improved similarity result, i.e. whether the similarity between the distribution of the bar width values and the distribution of the space width values has improved. In other words, it is checked whether a potential adjustment of the edge field has the result that the deviation of the bar width values from the space width values that belong to the same width level tends to be reduced and that they are thus closer to their associated reference width.

For example, for this purpose, one of the histograms is shifted by the histogram shift value that corresponds, for example, to the amount of the difference of the first estimate and the second estimate, while the respective other histogram is not shifted. Alternatively, both histograms can also be shifted by the same histogram shift value that, in such a case, in particular corresponds to half the amount of the difference between the first and the second estimate.

If the difference between the first and second estimate is positive, for example, an overprinting situation can hereby be determined and the bar width histogram is shifted by the difference amount in a negative X direction or the space width histogram is shifted by the difference amount in a positive X direction. Alternatively, in such a case, the bar width histogram can be shifted by ½·difference amount in a negative X direction and the space width histogram by ½·difference amount in a positive X direction.

If the difference between the first and second estimate is negative, for example, an overexposure situation can hereby be determined and the bar width histogram is shifted by the difference amount in a positive X direction or the space width histogram is shifted by the difference amount in a negative X direction.

Alternatively, in such a case, the bar width histogram can be shifted by ½·difference amount in a positive X direction and the space width histogram by ½·difference amount in a negative X direction.

If the histogram shift value=½·difference amount, it can occur that the histogram shift value is not an integer. In such cases, the histogram shift value can be rounded up to an integer for the shift of one histogram and can be rounded down to an integer for the shift of the respective other histogram. The shift of a histogram is equivalent to an adjustment of the assignment of width values and histogram values of an associated histogram. For example, with a shift, each histogram value is now assigned a width value that is smaller or larger by the histogram shift value. The shift value can in particular be determined based on the histogram shift value. For example, in cases in which only one of the histograms is shifted, the shift value can amount to shift value=¼·histogram shift value, while in cases in which both histograms, i.e. the bar width histogram and the space width histogram, are shifted, the shift value can amount to shift value=½·histogram shift value. If the shift value is not an integer, the shift value can be rounded up or down to an integer to enable a shift of the edges by a corresponding number of pixels.

According to one embodiment, the histogram shift value and a predefined number of noise values are added together to generate additional histogram shift values, wherein the method steps 2 and 3 of the preceding embodiment are further carried out for the additional histogram shift values and corresponding additional similarity values are generated,

wherein the histogram shift value or one of the additional histogram shift values that is associated with the similarity value of the largest magnitude of the further similarity value and the additional similarity values is used to determine the shift value for the adjustment of the edge field.

In particular, the robustness of the results can hereby be improved since a plurality of further shifts are tested. The noise values can assume small values, in particular the smallest values in relation to the resolution. If width values are, for example, specified in pixels, the noise value can be 1 and −1, which corresponds to an increase or decrease in the histogram shift value by 1 pixel width. Based on the resulting two additional histogram shift values, two additional similarity values can be determined. If an improved similarity result is achieved for one of the additional histogram shift values compared to the histogram shift value, the corresponding additional histogram shift value can be used to determine the shift value with which the adjustment of the edge field takes place. If there are a plurality of maximum similarity values, a random decision can, for example, be made as to which associated histogram shift value is selected, or the histogram shift value can be selected that has the smallest amount and that thus results in the smallest adjustment of the edges of the edge field.

According to one embodiment, the adjustment of the edge field comprises a first adjustment that comprises that for all the edges of the edge field:
if the first estimate is smaller than the second estimate, the edges of a respective bar are shifted by the shift value, in particular in opposite, diverging directions, such that the width of the respective bar is increased by half the amount of the estimate difference, and the edges of a respective space are shifted by the shift value, in particular in opposite, converging directions, such that the width of the respective space is reduced by half the amount of the estimate difference, wherein, if the first estimate is larger than the second estimate, the edges of a respective bar are shifted by the shift value, in particular in opposite, converging directions, such that the width of the respective bar is reduced by half the amount of the estimate difference, and the edges of the respective space are shifted by the shift value, in particular in opposite, diverging directions, such that the width of the respective space is reduced by half the amount of the estimate difference, wherein the shift value corresponds to a quarter of the amount of the estimate difference.

The setting of the shift value to the above amount takes place as follows: Since the first estimate corresponds to an estimate of the reference width of the first width level on the basis of the bar width values and the second estimate corresponds to an estimate of the reference width of the first width level on the basis of the space width values, the actual reference width should lie between these two estimates. Accordingly, an average of the first and second estimate can be defined as the estimated reference width of the first width level. The deviation of the first and/or second estimate from the averaged estimated reference width then corresponds to the difference width value by which a respective bar width or a respective space width is or should be increased or reduced. This difference width value in particular corresponds to half the amount of the difference between the first and second estimate. Since a bar or a space has two adjacent edges, the adjacent edges must each be shifted by ½·difference width value, i.e. by a quarter of the amount of the difference between the first estimate and the second estimate in order to achieve the increase or decrease of a respective bar width or space width by the difference width value. It is hereby in particular achieved that the deviation of a respective bar width and/or space width from the reference width of its associated width level is minimized. The edges of a respective bar or a respective space are, for example, the edges adjacent to the respective bar or the edges adjacent to the respective space.

According to one embodiment, the adjustment of the edge field further comprises a second adjustment, wherein the second adjustment comprises that:
(1) a first estimate of the reference width of the respective further width level takes place on the basis of the bar width values and a second estimate of the reference width of the respective further width level takes place on the basis of the space width values for each further width level of the predefined number of width levels in accordance with the estimate method according to any one of the preceding embodiments,
(2) an averaged estimated reference width for each width level is determined based on an averaging of the respective first estimate and the respective second estimate,
(3) an iteration takes place over the edge field,
(4) wherein, for each edge, based on the averaged estimated reference widths of the width levels, it is determined which width level the two adjacent barcode elements belong to,
(5) wherein, for each edge, it is further determined whether a shift of the edge by a predefined fine adjustment value Δx in one of the two directions leads to a reduction in the distance of both adjacent elements from the averaged estimated reference width of their associated width level and, in the event of a positive determination, a shift of the respective edge by Δx takes place in the corresponding direction and step (5) is repeated for the shifted edge,
(6) wherein, in the event of a negative determination, no shift of the respective edge takes place and the preceding steps (4) to (6) are carried out for the next edge.

In other words, the first estimate on the basis of the bar width values and the second estimate on the basis of the space width values are used to determine a final estimate that corresponds to an averaging of the two estimates that ideally comes closest to the actual reference width of a respective width level. Thus, a respective averaged estimated reference width results for each width level. On the basis of these averaged estimated reference widths, a decision can then be made for each edge as to whether a shift of the edge position by the fine adjustment value Δx leads to a reduction in the deviation of the width of the adjacent elements, i.e. of the adjacent bar and the adjacent space, from the respective reference width. The fine adjustment value Δx can in particular correspond to the width of a pixel. To determine which width level a respective bar or a respective space is to be assigned to, the width of the respective bar or of the respective space can, for example, be compared with the averaged estimated reference widths of the width levels and the width level whose averaged estimated reference width has the smallest distance from the detected width of the barcode element can be selected as the associated width level. The second adjustment thus in particular corresponds to a fine adjustment of the edge field, while the first adjustment in particular corresponds to a coarse adjustment of the edge field. Preferably, the second adjustment can take place after the first adjustment. However, the first and second adjustment can also be applied independently of one another, i.e. the implementation of the first adjustment is not a necessary condition for the implementation of the second adjustment, or vice versa.

The first and second estimate of the reference width of the respective further width level can, for example, take place on the basis of equations (4) and (5), wherein the equations (4) and (5) can then be adapted such that they start with the index i=a+1, where a is the index at which the estimate of the reference width of a previous width level was completed. For example, a first estimate of the reference width of the second width level can take place on the basis of the bar width values based on an adapted equation (4):

$${b}_{s u m} = {\sum }_{i = x + 1}^{w} {b}_{i} \qquad ( 6 )$$

where bₛᵤₘ corresponds to the sum of the bar width histogram values for the (x+1)th to wth width value, bᵢ corresponds to the bar width histogram value for the ith width value, i indicates the index of the width value, and w indicates the index of the width value for which the condition bₛᵤₘ>first threshold value is satisfied; here, x is the value from equation (4) at which the estimate of the reference width of the previous, i.e. the first, width level was completed. In the same way, the second estimate of the reference width of the second width level can take place on the basis of the space width values, wherein equation (5) is used in this case. The first and second estimate of the reference width of the further width levels can also take place in the same way.

If the edge field is, for example, configured as a strip, the iteration over the edge field can take place from one end of the strip to the other end, e.g. from left to right or from right to left.

Due to the individual adjustment of the edges, local errors, in particular adjustment errors that could not be corrected, for example, by a global adjustment of the edges of the edge field or that were generated by the global adjustment, can be improved in the edge field in order to further increase the readability. Evaluations of the adaptive method, in which a global adjustment of the edges of the edge field, such as described in one of the previous passages, takes place in combination with an individual adjustment, have additionally shown that the probability of false readings is greatly reduced. For example, a reduction in incorrect readings by 40% could be observed.

According to one embodiment, the first estimate of the reference width of the width level and the second estimate of the reference width of the width level are determined using a first edge field section, wherein the first edge field section comprises a first part section of the edge field, wherein further first estimates of the reference width of the first width level and further second estimates of the reference width of the first width level are determined using respective further edge field sections, wherein the first edge field section is adjusted using the first and second estimate and a respective further edge field section is adjusted using the respective further first estimate and the respective further second estimate. The readability of barcodes that have been perspectively recorded in a distorted or curved manner can hereby be improved, for example. The distortions and curvatures lead, for example, to different first and second estimates in the different edge field sections, which can be considered by the method described above. Furthermore, it can be checked whether the respective further first or further second estimates and the first or second estimate deviate from one another by a predefined threshold value before a specific adjustment takes place for each edge field section. In other words, it can be determined whether there are significant changes in the measured values, i.e. the width values of the bars or spaces, along the edge field and in particular between the edge field sections, and the above method can only be applied in the event of a corresponding positive determination.

According to one embodiment, a final similarity value is determined in accordance with a similarity determination method according to any one of the preceding embodiments for the adjusted edge field, wherein a further processing takes place on the basis of the adjusted edge field if the final similarity value is larger than a predetermined final similarity threshold value and/or if the final similarity value is higher than the similarity value. Thus, after the adjustment of the edge field has taken place, a final check is carried out to determine whether the implemented changes have led to an improved result with regard to the distribution of the bar width values and the space width values, i.e. whether the bar width values and space width values are closer to their respective reference width, at least on average. For example, the predetermined final similarity threshold value is equal to the predetermined similarity threshold value. However, the predetermined final similarity threshold value can also differ from the predetermined similarity threshold value. For example, higher demands can be made on the final similarity threshold value so that it is higher. Additionally or alternatively, the final similarity value can be compared with the similarity value, wherein a further processing takes place on the basis of the adjusted edge field if the final similarity value is higher than the similarity value.

A further aspect of the invention relates to a method for reading barcodes, said method comprising that:
a barcode is captured by means of an image acquisition apparatus, on which barcode bars and spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
using the edge field, at least a first estimate of a reference width of a first width level takes place on the basis of the bar width values and a second estimate of the reference width of the first width level takes place on the basis of the space width values;
a shift value is determined based on a difference of the first estimate and the second estimate; and
the edge field is adjusted based on the shift value,
wherein the barcode is decoded based on the adjusted edge field.

A further aspect of the invention relates to a method for reading barcodes that comprises that
a barcode is captured by means of an image acquisition apparatus, said barcode comprising barcode elements in the form of bars and spaces, wherein the bars and the spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
wherein an adjustment of the edge field takes place and comprises that:
(1) a first estimate of the reference width of the respective width level takes place on the basis of the bar width values and a second estimate of the reference width of the respective width level takes place on the basis of the space width values for each width level of the predefined number of width levels,
(2) an averaged estimated reference width for each width level is determined based on an averaging of the respective first estimate and the respective second estimate,
(3) an iteration takes place over the edge field,
(4) wherein, for each edge, based on the averaged estimated reference widths of the width levels, it is determined which width level the two adjacent barcode elements belong to,
(5) wherein, for each edge, it is further determined whether a shift of the edge by a predefined fine adjustment value Δx in one of the two directions leads to a reduction in the distance of both adjacent elements from the averaged estimated reference width of their associated width level and, in the event of a positive determination, a shift of the respective edge by Δx takes place in the corresponding direction and step (5) is repeated for the shifted edge,
(6) wherein, in the event of a negative determination, no shift of the respective edge takes place and the preceding steps (4) to (6) are carried out for the next edge;
wherein the barcode is decoded based on the adjusted edge field.

It should be noted that the above statements apply to all of the methods according to the invention described herein; this in particular applies with respect to advantages and embodiments.

A further aspect of the invention relates to a code reading apparatus comprising an image acquisition apparatus for capturing a barcode and a control and evaluation unit in which a method for reading a barcode according to any one of the preceding statements is implemented.

The image acquisition apparatus is, for example, a barcode scanner, a camera or another suitable image sensor. The control and evaluation unit is preferably part of the code reading apparatus itself and is in particular accommodated in its housing. However, an at least partly external control and evaluation unit is also conceivable. The control and evaluation unit is, for example, a microcontroller, a computer or another computing unit. The control and evaluation unit in particular comprises a memory and a processor.

The statements regarding the method according to the invention apply accordingly to the code reading apparatus; this in particular applies with respect to advantages and embodiments.

The invention will be presented purely by way of example with reference to the drawings in the following. There are shown:

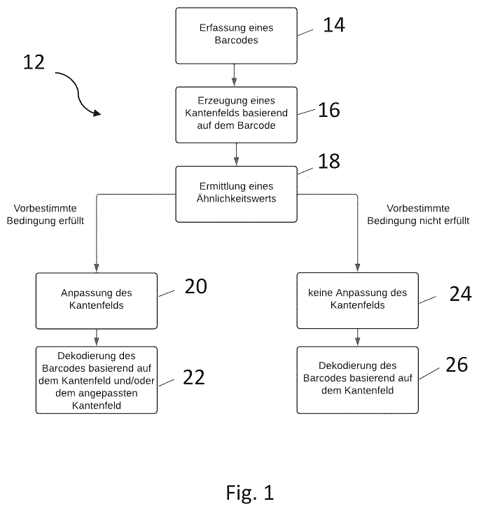

FIG. 1 a flowchart of a method for reading barcodes;

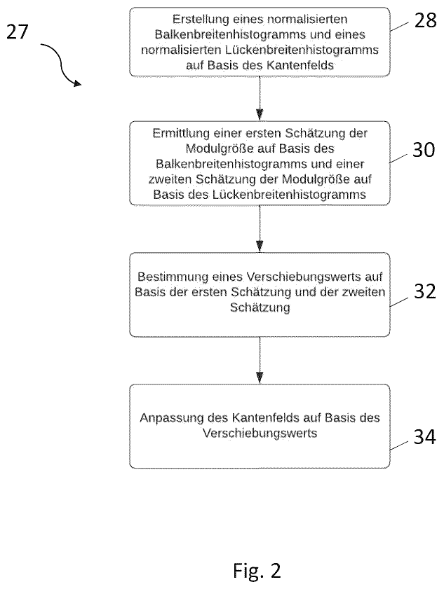

FIG. 2 a flowchart of a first method for adjusting an edge field;

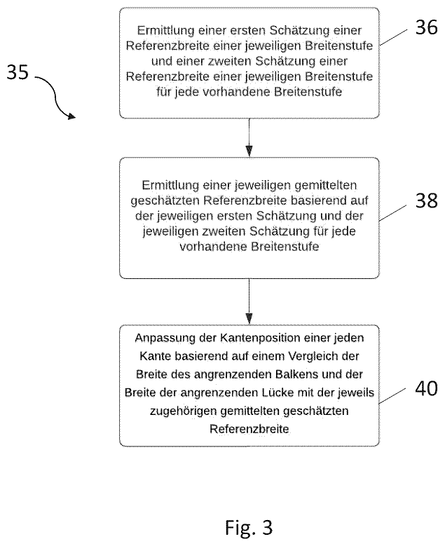

FIG. 3 a flowchart of a second method for adjusting an edge field;

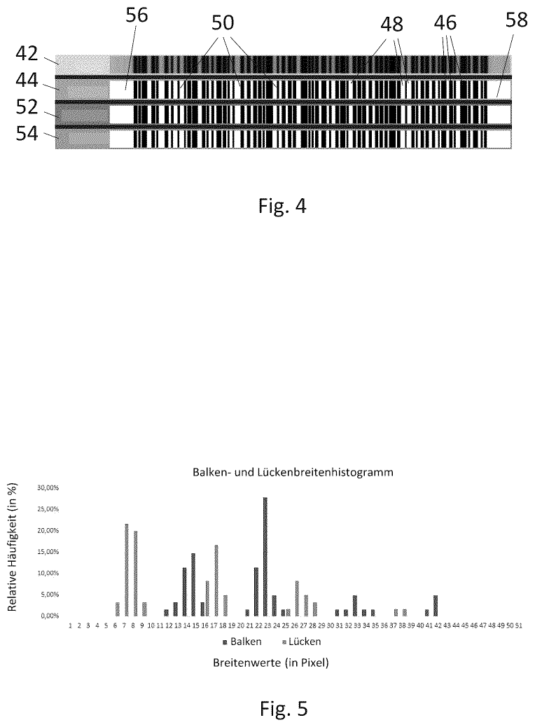

FIG. 4 a gray value scan of a barcode and a corresponding edge field and further adjusted edge field variants;

FIG. 5 a bar width histogram and a space width histogram for the edge field of FIG. 4;

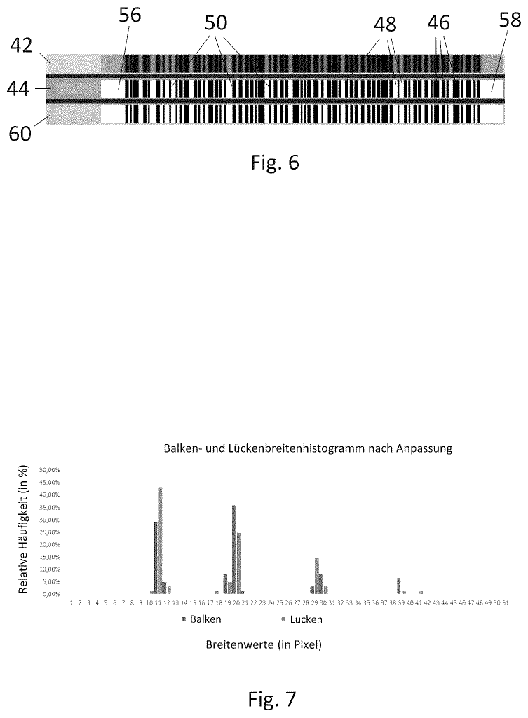

FIG. 6 a gray value scan of a barcode and a corresponding edge field and an adjusted edge field after an adjustment according to an embodiment of the invention; and

FIG. 7 a bar width histogram and a space width histogram for the adjusted edge field of FIG. 6.

FIG. 1 illustrates a flowchart of a method 12 for reading barcodes. In a first method step 14, a barcode that comprises barcode elements in the form of bars 46 and spaces 48 is captured by means of an image acquisition apparatus, wherein the bars 46 and the spaces 48 arranged between the bars are arranged in an alternating manner, wherein a respective bar 46 and/or a respective space 48 can be assigned to a width level of a predefined number of width levels, wherein each width level has a respective reference width. Furthermore, in a next method step 16, an edge field 44 is generated based on the captured barcode, wherein an edge 50 in the edge field 44 indicates a bar-space transition. Using the edge field 44, in a method step 18, a similarity value is then determined that indicates a similarity between a distribution of bar width values and a distribution of space width values. If the similarity value satisfies a predetermined condition, in a further method step 20, an adjustment of the edge field 44 takes place and the barcode is decoded in a method step 22 based on the edge field 44 and/or the adjusted edge field 54. If the similarity value does not satisfy the predetermined condition, the edge field 44 is not adjusted according to step 24 and the barcode is decoded in step 26 based on the edge field 44, i.e. the originally generated edge field 44.

FIG. 2 illustrates a first method 27 for adjusting an edge field 44 according to an embodiment of the invention. In this respect, in a first step, a normalized bar width histogram and a normalized space width histogram are created. The bar width histogram and the space width histogram are created using the edge field 44. In this respect, a histogram value indicates a relative frequency of a bar width value or a space width value. Subsequently, in step 30, a first estimate of the module size, i.e. the reference width of the smallest width level, takes place on the basis of the bar width histogram and a second estimate of the module size takes place on the basis of the space width histogram.

The first or second estimate can be determined in two different ways. In this respect, starting with the histogram value of the smallest measurable width value, i.e. the bar width value or space width value, the histogram values, i.e. the relative frequency of the width values, are added up iteratively until the added-up histogram value exceeds a threshold value of 0.2, i.e. until 20% of the bar width values or space width values have been considered. The bar width value or space width value can then be defined as the first or second estimate from which this condition is satisfied. Another possibility is to determine a weighted first or second estimate in that a weighting of the bar width values or the space width values is performed based on the relative frequency of the bar width values or the space width values that were considered until the above-mentioned exceeding of the threshold value. Using the weighted bar width values or space width values, an average value can then be determined that represents a weighted estimate of the module size for the bars 46 or spaces 48.

In a next step 32, a shift value can be determined on the basis of the first estimate and the second estimate. In this respect, the shift value is a quarter of the amount of the difference between the first estimate of the module size and the second estimate of the module size (estimate difference). It is hereby achieved that a shift of the edges 50 of the edge field 44 results in the width of a bar 46 or a space 48 approaching its associated reference width. In the last step 34, the edges 50 of the edge field 44 are adjusted or shifted by means of the shift value. If the first estimate is smaller than the second estimate, the edges 50 adjacent to a respective bar 46 are shifted by the shift value in opposite, in particular diverging, directions such that the width of the respective bar 46 is increased by half the amount of the estimate difference, and the edges 50 adjacent to a respective space 48 are shifted by the shift value in opposite, in particular converging, directions such that the width of the respective space 48 is reduced by half the amount of the estimate difference. Furthermore, if the first estimate is larger than the second estimate, the edges 50 adjacent to a respective bar 46 are shifted by the shift value in opposite, converging directions such that the width of the respective bar 46 is reduced by half the amount of the estimate difference, and the edges 50 adjacent to a respective space 48 are shifted by the shift value, in particular in opposite, converging directions, such that the width of the respective space 48 is reduced by half the amount of the estimate difference. The adjusted edge field in particular has an improved similarity between a distribution of bar width values and a distribution of space width values.

FIG. 3 illustrates a second method 35 for adjusting an edge field 44 according to an embodiment of the invention. In step 36, a determination of a first estimate of a reference width of a respective width level and of a second estimate of a reference width of a respective width level takes place for each existing width level. The first and second estimate of the reference width of the first width level, i.e. the module size, can take place according to the description of FIG. 2. For the second and the further width levels, the above-described method can be adjusted such that the histogram sum for the width values starts with the index i=a+1, where a is the index at which the estimate of the reference width of a previous width level was completed. In step 38, for each existing width level, a determination of a respective averaged estimated reference width takes place based on the respective first estimate and the respective second estimate. The respective averaged estimated reference width thus represents a final estimate of the reference width of a respective width level that can be used as a comparative variable to determine how much a bar 46 or a space 48 deviates from the reference width of the associated width level. Accordingly, in a step 40, an adjustment of the edge position of each edge 50 can take place based on a comparison of the width of the bar 46 adjacent to the edge 50 and of the width of the space 48 adjacent to the edge 50 with the respective associated reference width. For each edge 50, a determination is in this respect made based on the averaged estimated reference widths of the width levels as to which width level the two adjacent barcode elements 46, 48, i.e. the adjacent bar 46 and the adjacent space 48, belong. For each edge 50, it is further determined whether a shift of the edge 50 by a predefined fine adjustment value Δx in one of the two directions, i.e. in a positive X direction or in a negative X direction, leads to a reduction of the distance of both adjacent barcode elements 46, 48 from the averaged estimated reference width of their associated width level, wherein, in the event of a positive determination, a shift of the respective edge 50 by Δx in the corresponding direction takes place and the preceding steps are carried out for the next edge 50. In the event of a negative determination, no shift of the respective edge 50 takes place and a transition to the next edge 50 takes place.

FIG. 4 shows a gray value scan 42 of a barcode as well as a corresponding edge field 44 and further adjusted edge field variants 52, 54. The gray value scan is generated, for example, by an image acquisition apparatus that captures the barcode as a gray value scan 42. In the present case, there is an overprinting situation, as can be seen from the gray value scan 42 or the edge field 44, i.e. the widths of the bars 46 are significantly wider than those of the spaces 48. After a binarization of the gray value scan 42, the edge field 44 is created, wherein the edges 50 of the edge field 44 indicate a black-white transition. As can be seen, the edge field 44 displays the bars 46 of the barcode in black and the spaces 48 of the barcode in white. The bars 46 and spaces 48 are in this respect arranged in an alternating manner along a straight strip. A start element 56 in the form of a white rectangle is in this respect arranged at one end of the strip and an end element 58 in the form of a white rectangle is arranged at the other end, wherein the start and end element 56 and 58 have a significantly larger width value compared to the bars 46 and spaces 48, by means of which width value a start or end of the barcode to be read can be determined. The two adjusted edge field variations 52, 54 have been generated in accordance with a jittering method according to the prior art. In the first adjusted edge field variant 52, the bars 46 have been widened by a predefined value and the spaces 48 have been narrowed accordingly, whereas, in the second adjusted edge field variant 54, the spaces 48 have been widened by a predefined value and the bars 46 have been narrowed accordingly. It can be seen that although the spaces 48 have been widened in the second adjusted edge field variant 54, the width of the spaces 48 is, however, still significantly narrower compared to the width of the bars 46. The first adjusted edge field variant 52, on the other hand, even causes a deterioration of the ratios between space widths and bar widths compared to the original edge field 44 and thus enhances the overprinting effect.

A bar width histogram and a space width histogram of the edge field 44 of FIG. 4 are shown in FIG. 5. In this respect, the relative frequency of a width value (in %) is shown on the Y axis and a respective width value (in pixels) is shown on the X axis.

It can be seen that the distribution of the bar width values and the distribution of the space width values differ greatly from one another. The overprinting, for example, has the result that the width values of the bars 46 tend to be larger than the width values of the spaces 48. In particular, there is hardly any overlap between the relative frequency of bar width values and space width values. Thus, the only width values for which both spaces 48 and bars 46 exist are the width values 16 and 25. This indicates a low similarity between the distribution of the bar width values and the distribution of the space width values. This dissimilarity can also be seen from FIG. 5. Furthermore, it can be seen from both the bar width histogram and the space width histogram that four width levels are provided for the present barcode. This can be recognized, for example, with reference to the compression of the columns in a width value range. However, it can also be seen from the graph that the respective width values associated with a width level, i.e. the width values that accumulate around a respective width value range, differ greatly from one another for bars 46 and spaces 48. For example, the width values for the spaces 48 associated with a first width level, i.e. the module size, are distributed in the width value range 6 to 9, while the width values for the bars 46 associated with the first width level are distributed in the width value range 12 to 15.

FIG. 6 shows the gray value scan 42 of the barcode as well as the corresponding edge field 44, as already shown in FIG. 4, and an adaptively adjusted edge field 60 after an adjustment according to an embodiment of the invention. The adaptively adjusted edge field 60 is in this respect the result of a first, in particular coarse, adjustment according to the method shown in FIG. 2 and a second, in particular fine, adjustment according to the method shown in FIG. 3. As can be seen from the adaptively adjusted edge field 60, the widths of the bars 46 and the spaces 48 are significantly more similar than in the adjusted edge field variants 52, 54 that were adjusted according to the jittering method from the prior art. Furthermore, compared to the prior art and FIG. 4, only one adjusted edge field variant was created, whereby the decoding load is considerably reduced.

FIG. 7 illustrates a bar width histogram and a space width histogram for the adaptively adjusted edge field 60 of FIG. 6. As can be seen in FIG. 7, the width values associated with a width level for both the bar width histogram and the space width histogram are condensed around the almost identical or at least a strongly overlapping width value range. Thus, the width values associated with the first width level for both histograms are distributed around the width value range 10 to 12, the width values associated with the second width level are distributed around the width value range 18 to 21, the width values associated with the third width level are distributed around the width value range 29 to 30 and the width values associated with the fourth width level are distributed around the width value range 39 to 41. This has the result that the similarity value, which indicates the similarity between the two distributions, becomes larger and is, for example, larger than a predefined similarity threshold value so that the adjustment of the edge field leads to an improved reading result of the barcode.

### REFERENCE NUMERAL LIST

12 method for reading barcodes
14-24 method steps
27 first method for adjusting an edge field
28-34 method steps
35 second method for adjusting an edge field
36-40 method steps
42 gray value scan
44 edge field
46 bars
48 spaces
50 edges
52 first adjusted edge field variant
54 second adjusted edge field variant
56 start element
58 end element
60 adaptively adjusted edge field

1-17. (canceled)

18. A method for reading barcodes, said method comprising that:
a barcode is captured by means of an image acquisition apparatus, said barcode comprising barcode elements in the form of bars and spaces, wherein the bars and the spaces arranged between the bars are arranged in an alternating manner, wherein a respective bar and/or a respective space can be assigned to a width level of a predefined number of width levels, wherein each width level has a respective reference width;
an edge field is generated based on the captured barcode, wherein an edge in the edge field indicates a bar-space transition;
using the edge field, a similarity value is determined that indicates a similarity between a distribution of bar width values and a distribution of space width values;
wherein an adjustment of the edge field takes place when the similarity value satisfies a predetermined condition; and
the barcode is decoded based on the edge field and/or the adjusted edge field.

19. The method according to claim 18,
wherein the distribution of the bar width values is determined based on a normalized bar width histogram and the distribution of the space width values is determined based on a normalized space width histogram,
wherein the similarity value zₛᵢₘ is determined based on the following equation:
$${z}_{sim , 1} = 1 - {\sum }_{i} \frac{{( {b}_{i} - {l}_{i} )}^{2}}{2 * ( {b}_{i} - {l}_{i} )}$$
where bᵢ indicates the histogram value of the bar width histogram for the ith width value and lᵢ indicates the histogram value of the space width histogram for the ith width value, wherein an adjustment of the edge field takes place if the similarity value is smaller than a predetermined similarity threshold value.

20. The method according to claim 18,
wherein the distribution of the bar width values is determined based on a normalized bar width histogram and the distribution of the space width values is determined based on a normalized space width histogram,
wherein a first estimate z₁ of a reference width of a first width level takes place on the basis of the bar width values and a second estimate z₂ of the reference width of the first width level takes place on the basis of the space width values,
wherein the similarity value z_{sim,2} is determined based on a difference between the first estimate z₁ and the second estimate z₂.

21. The method according to claim 20,
wherein the first estimate z₁ takes place using the normalized bar width histogram, wherein the histogram values of the bar width histogram are added up according to the following equation:
$${b}_{sum} = {\sum }_{i = 1}^{x} {b}_{i}$$
where bₛᵤₘ corresponds to the sum of the bar width histogram values for the first to xth width value, bᵢ corresponds to the bar width histogram value for the ith width value, i indicates the index of the width value, and x indicates the index of the width value for which the condition bₛᵤₘ>first threshold value is satisfied,
wherein the xth width value is defined as the first estimate z₁ or the first estimate z₁ is calculated as a weighted bar width value according to the equation
$${z}_{1} = {\sum }_{i = 1}^{x} \frac{{b}_{i}}{{b}_{sum}} \cdot B ( i ) ,$$
where B(i) indicates the ith width value,
wherein the second estimate z₂ takes place using the normalized space width histogram, wherein the histogram values of the space width histogram are added up according to the following equation:
$${l}_{sum} = {\sum }_{i = 1}^{y} {l}_{i}$$
where lₛᵤₘ corresponds to the sum of the space width histogram values for the first to xth width value, lᵢ corresponds to the space width histogram value for the ith width value, i indicates the index of the width value, and y indicates the index of the width value for which the condition lₛᵤₘ>second threshold valve is satisfied,
wherein the yth width value is defined as the second estimate z₂ or the second estimate z₂ is calculated as a weighted space width value according to the equation
$${z}_{2} = {\sum }_{i = 1}^{y} \frac{{l}_{i}}{{l}_{sum}} \cdot B ( i ) ,$$
where B(i) indicates the ith width value.

22. The method according to claim 18,
wherein the reference width of the first width level is the module size.

23. The method according to claim 18,
wherein the edge field comprises a plurality of pixels, wherein the pixels associated with a bar have a first pixel color and the pixels associated with a space have a second pixel color that is different from the first pixel color, wherein the similarity value corresponds to a ratio of pixels having a first pixel color and pixels having a second pixel color, wherein an adjustment of the edge field takes place if the similarity value is larger than a predetermined first similarity threshold value or smaller than a second similarity threshold value.

24. The method according to claim 18,
wherein the similarity value is generated using an AI, wherein the training data of the AI comprise a plurality of sample edge fields and associated labels, wherein the label of an associated sample edge field indicates a similarity between a distribution of bar width values of the associated sample edge field and a distribution of space width values of the associated sample edge field.

25. The method according to claim 20,
wherein the adjustment of the edge field comprises that:
a shift value is determined based on an estimate difference that corresponds to a difference of the first estimate and the second estimate, and
the edge field is adjusted based on the shift value.

26. The method according to claim 25,
(1) wherein a histogram shift value is determined based on the estimate difference,
(2) wherein the bar width histogram and/or the space width histogram is/are shifted by the histogram shift value,
(3) wherein a further similarity value is determined for the shifted bar width histogram and the space width histogram, for the shifted space width histogram and the bar width histogram, or for the shifted bar width histogram and the shifted space width histogram, wherein either the similarity value zₛᵢₘ is determined based on the following equation:
$${z}_{sim , 1} = 1 - {\sum }_{i} \frac{{( {b}_{i} - {l}_{i} )}^{2}}{2 * ( {b}_{i} - {l}_{i} )}$$
where bᵢ indicates the histogram value of the bar width histogram for the ith width value and lᵢ indicates the histogram value of the space width histogram for the ith width value, wherein an adjustment of the edge field takes place if the similarity value is smaller than a predetermined similarity threshold value or a first estimate z₁ of a reference width of a first width level takes place on the basis of the bar width values and a second estimate z₂ of the reference width of the first width level takes place on the basis of the space width values,
wherein the similarity value z_{sim,2} is determined based on a difference between the first estimate z₁ and the second estimate z₂;
(4) wherein an adjustment of the edge field takes place based on the shift value, which is determined based on the histogram shift value, when the further similarity value satisfies a predetermined condition.

27. The method according to claim 26,
wherein the histogram shift value and a predefined number of noise values are added together to generate additional histogram shift values,
wherein the method steps are further carried out for the additional histogram shift values and corresponding additional similarity values are generated,
wherein the histogram shift value or one of the additional histogram shift values that is associated with the similarity value of the largest magnitude of the further similarity value and the additional similarity values is used to determine the shift value for the adjustment of the edge field.

28. The method according to claim 25,
wherein the adjustment of the edge field comprises a first adjustment that comprises that for all the bars and spaces of the edge field:
if the first estimate is smaller than the second estimate, the edges of a respective bar are shifted by the shift value, such that the width of the respective bar is increased by half the amount of the estimate difference, and the edges of a respective space are shifted by the shift value, such that the width of the respective space is reduced by half the amount of the estimate difference,
wherein, if the first estimate is larger than the second estimate, the edges of a respective bar are shifted by the shift value, such that the width of the respective bar is reduced by half the amount of the estimate difference, and the edges of the respective space are shifted by the shift value, such that the width of the respective space is reduced by half the amount of the estimate difference,
wherein the shift value corresponds to a quarter of the amount of the estimate difference.

29. The method according to claim 20,
wherein the adjustment of the edge field further comprises a second adjustment that comprises that:
(1) a first estimate of the reference width of the respective further width level takes place on the basis of the bar width values and a second estimate of the reference width of the respective further width level takes place on the basis of the space width values for each further width level of the predefined number of width levels in accordance with the estimate method according to claim 3 or 4,
(2) an averaged estimated reference width for each width level is determined based on an averaging of the respective first estimate and the respective second estimate,
(3) an iteration takes place over the edge field,
(4) wherein, for each edge, based on the averaged estimated reference widths of the width levels, it is determined which width level the two adjacent barcode elements belong to,
(5) wherein, for each edge, it is further determined whether a shift of the edge by a predefined fine adjustment value Δx in one of the two directions leads to a reduction in the distance of both adjacent elements from the averaged estimated reference width of their associated width level and, in the event of a positive determination, a shift of the respective edge by Δx takes place in the corresponding direction and step is repeated for the shifted edge,
(6) wherein, in the event of a negative determination, no shift of the respective edge takes place and the preceding steps to are carried out for the next edge.

30. The method according to claim 18,
wherein the first estimate and the second estimate are determined using a first edge field section, wherein the first edge field section comprises a first part section of the edge field, wherein further first estimates of the reference width of the first width level and further second estimates of the reference width of the first width level are determined using respective further edge field sections, wherein the first edge field section is adjusted using the first and second estimate and each of the respective further edge field sections are adjusted using the respective further first estimate and the respective further second estimate.

31. The method according to claim 18,
wherein a final similarity value is determined based on either the similarity value zₛᵢₘ is determined based on the following equation:
$${z}_{sim , 1} = 1 - {\sum }_{i} \frac{{( {b}_{i} - {l}_{i} )}^{2}}{2 * ( {b}_{i} - {l}_{i} )}$$
where bᵢ indicates the histogram value of the bar width histogram for the ith width value and lᵢ indicates the histogram value of the space width histogram for the ith width value, wherein an adjustment of the edge field takes place if the similarity value is smaller than a predetermined similarity threshold value or a first estimate z₁ of a reference width of a first width level takes place on the basis of the bar width values and a second estimate z₂ of the reference width of the first width level takes place on the basis of the space width values,
wherein the similarity value z_{sim,2} is determined based on a difference between the first estimate z₁ and the second estimate z₂ for the adjusted edge field, wherein a further processing takes place on the basis of the adjusted edge field if the final similarity value is larger than a predetermined final similarity threshold value and/or if the final similarity value is higher than the similarity value.

32. A method for reading barcodes, said method comprising that:
a barcode is captured by means of an image acquisition apparatus, on which barcode bars and spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
using the edge field, at least a first estimate of a reference width of a first width level takes place on the basis of the bar width values and a second estimate of the reference width of the first width level takes place on the basis of the space width values;
a shift value is determined based on a difference of the first estimate value and the second estimate; and
the edge field is adjusted based on the shift value,
wherein the barcode is decoded based on the adjusted edge field.

33. A method for reading barcodes, said method comprising that
a barcode is captured by means of an image acquisition apparatus, said barcode comprising barcode elements in the form of bars and spaces, wherein the bars and the spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
wherein an adjustment of the edge field takes place and comprises that:
(1) a first estimate of the reference width of the respective width level takes place on the basis of the bar width values and a second estimate of the reference width of the respective width level takes place on the basis of the space width values for each width level of the predefined number of width levels,
(2) an averaged estimated reference width for each width level is determined based on an averaging of the respective first estimate and the respective second estimate,
(3) an iteration takes place over the edge field,
(4) wherein, for each edge, based on the averaged estimated reference widths of the width levels, it is determined which width level the two adjacent barcode elements belong to,
(5) wherein, for each edge, it is further determined whether a shift of the edge by a predefined fine adjustment value Δx in one of the two directions leads to a reduction in the distance of both adjacent elements from the averaged estimated reference width of their associated width level and, in the event of a positive determination, a shift of the respective edge by Δx takes place in the corresponding direction and step is repeated for the shifted edge,
(6) wherein, in the event of a negative determination, no shift of the respective edge takes place and the preceding steps to are carried out for the next edge;
wherein the barcode is decoded based on the adjusted edge field.

34. A code reading apparatus comprising an image acquisition apparatus for capturing a barcode and a control and evaluation unit in which a method for reading a barcode is implemented, said method comprising that:
a barcode is captured by means of an image acquisition apparatus, said barcode comprising barcode elements in the form of bars and spaces, wherein the bars and the spaces arranged between the bars are arranged in an alternating manner, wherein a respective bar and/or a respective space can be assigned to a width level of a predefined number of width levels, wherein each width level has a respective reference width;
an edge field is generated based on the captured barcode, wherein an edge in the edge field indicates a bar-space transition;
using the edge field, a similarity value is determined that indicates a similarity between a distribution of bar width values and a distribution of space width values;
wherein an adjustment of the edge field takes place when the similarity value satisfies a predetermined condition; and
the barcode is decoded based on the edge field and/or the adjusted edge field, or a barcode is captured by means of an image acquisition apparatus, on which barcode bars and spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
using the edge field, at least a first estimate of a reference width of a first width level takes place on the basis of the bar width values and a second estimate of the reference width of the first width level takes place on the basis of the space width values;
a shift value is determined based on a difference of the first estimate value and the second estimate; and
the edge field is adjusted based on the shift value,
wherein the barcode is decoded based on the adjusted edge field, or a barcode is captured by means of an image acquisition apparatus, said barcode comprising barcode elements in the form of bars and spaces, wherein the bars and the spaces arranged between the bars are arranged in an alternating manner, wherein the width of a respective space and/or the width of a respective bar corresponds to a reference width of a respective width level of a predefined number of width levels;
an edge field is generated based on the captured barcode, wherein an edge in the edge field indicates a bar-space transition;
wherein an adjustment of the edge field takes place and comprises that:
(1) a first estimate of the reference width of the respective width level takes place on the basis of the bar width values and a second estimate of the reference width of the respective width level takes place on the basis of the space width values for each width level of the predefined number of width levels,
(2) an averaged estimated reference width for each width level is determined based on an averaging of the respective first estimate and the respective second estimate,
(3) an iteration takes place over the edge field,
(4) wherein, for each edge, based on the averaged estimated reference widths of the width levels, it is determined which width level the two adjacent barcode elements belong to,
(5) wherein, for each edge, it is further determined whether a shift of the edge by a predefined fine adjustment value Δx in one of the two directions leads to a reduction in the distance of both adjacent elements from the averaged estimated reference width of their associated width level and, in the event of a positive determination, a shift of the respective edge by Δx takes place in the corresponding direction and step is repeated for the shifted edge,
(6) wherein, in the event of a negative determination, no shift of the respective edge takes place and the preceding steps to are carried out for the next edge;
wherein the barcode is decoded based on the adjusted edge field.

35. The method according to claim 28,
wherein the edges of a respective bar are shifted by the shift value in opposite diverging directions.

36. The method according to claim 28,
wherein the edges of a respective space are shifted by the shift value in opposite converging directions.

37. The method according to claim 28,
wherein, if the first estimate is larger than the second estimate, the edges of a respective bar are shifted by the shift value in opposite converging directions.

38. The method according to claim 28,
wherein, if the first estimate is larger than the second estimate, the edges of the respective space are shifted by the shift value in opposite diverging directions.
